(19) United States
(12) Patent Application Publication
(10) Pub. No.: US 2025/0376384 A1
(43) Pub. Date: Dec. 11, 2025

(54) CARBON DIOXIDE NEGATIVE DIRECT LITHIUM EXTRACTION (DLE) PROCESS: BIPOLAR ELECTRODIALYSIS (BPED) TO LITHIUM HYDROXIDE MONOHYDRATE AND LITHIUM CARBONATE

(71) Applicant: ENERGY EXPLORATION TECHNOLOGIES, INC., Austin, TX (US)

(72) Inventors: Amit PATWARDHAN, Austin, TX (US); Angelo KIRCHON, Austin, TX (US); Robert HELLMAN, Austin, TX (US)

(73) Assignee: ENERGY EXPLORATION TECHNOLOGIES, INC., Austin, TX (US)

(21) Appl. No.: 18/877,121

(22) PCT Filed: Jun. 20, 2023
(86) PCT No.: PCT/US2023/025764

§ 371 Date: Dec. 19, 2024

Related U.S. Application Data
(60) Provisional application No. 63/353,768, filed on Jun. 20, 2022.

(51) Int. Cl. C01D 15/08; B01D 61/44

(52) U.S. Cl. CPC C01D 15/08; B01D 61/445

(57) ABSTRACT

A lithium compound generating system can include a source of a first CO₂ containing gas, a CO₂ capture unit, a lithium-containing source feed, a bipolar electrodialysis unit, and a first reaction site. The first CO₂ containing gas can include a first concentration of CO₂. The CO₂ capture unit can receive the first CO₂ containing gas and output a release gas including a second concentration of CO₂ greater than the first, the second concentration achieved by carbon capture. The lithium-containing source feed can provide a lithium-containing material. The bipolar electrodialysis unit can process the lithium-containing material and generate an aqueous LiOH product. The first reaction site can be configured to receive the release gas and at least a first portion of the aqueous LiOH product, facilitate a first reaction therein to yield an amount of Li₂CO₃. A second reaction site can convert a second portion of the aqueous LiOH product into LiOH·H₂O.

This application claims the benefit of priority to U.S. Provisional Application No. 63/353,768, filed on Jun. 20, 2022, the entire contents of which are hereby incorporated by reference.

### BACKGROUND

Bipolar Electrodialysis or BPED is the combination of electrodialysis for salt separation with electrodialysis water splitting for the conversion of a salt into its corresponding acid and base. The bipolar membranes enhance the splitting of water into protons and hydroxide ions. In conventional BPED lithium (Li) extraction processes, highly purified lithium brine solution is generated as an intermediate, which can, for example, be transformed into lithium hydroxide for lithium-ion batteries, manufacture of stearic and/or other fatty acids (e.g., grease thickeners), a carbon dioxide scrubber, a precursor material for other useful lithium compounds (e.g., lithium fluoride, lithium carbonate), and/or an additive for some ceramic and/or Portland cement formulations.

However, the historical issue with commercialization of this technology is that the Li-containing brine solution has needed to be highly purified. For example, utilizing a conventional/commercially available Cation Exchange Membrane (CEM) in a BPED process generally allows co-permeation of other cations from the feed stream, along with the desired lithium. The presence of Mg (magnesium) and Ca (calcium) salts can lead to the formation of insoluble hydroxides in the base product, which tend to precipitate in the process and clog/obstruct the CEM. The resulting obstruction can reduce the rate of Li production and eventually block flow of the base product, which can impede productivity/throughput and, ultimately, damage the process equipment and/or shut down the process.

In another aspect, there has been a recent drive to develop systems and/or process that are considered carbon-negative, for example, able to capture carbon dioxide (CO₂) and thereby reduce the amount of CO₂ released into the atmosphere.

### DRA WINGS

The Detailed Description is described with reference to the accompanying figures.

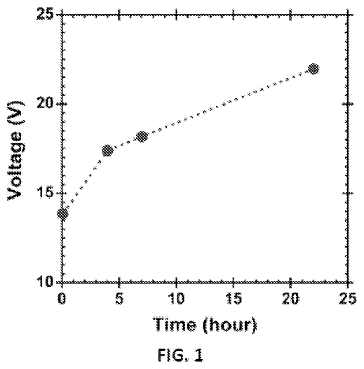

FIG. 1 is a plot of voltage versus time during a constant-current commercial membrane test as part of a conventional BPED (bipolar electrodialysis) procedure.

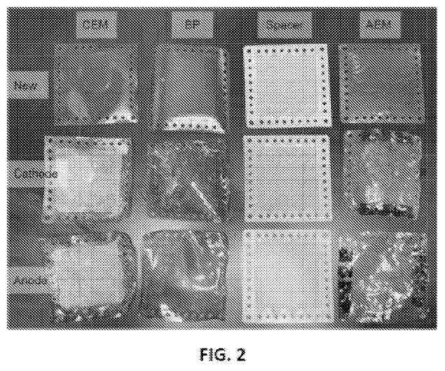

FIG. 2 is a photographic view of a plurality of commercial membranes before and after use in BPED test using ˜1500 ppm hardness, with representative membranes taken from near the cathode and anode.

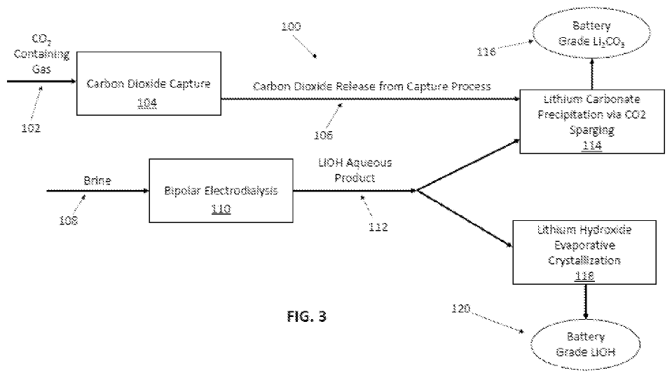

FIG. 3 is a schematic diagram of a carbon negative and/or carbon neutral lithium BPED-based extraction and product generation process, in accordance with an example embodiment of the present disclosure.

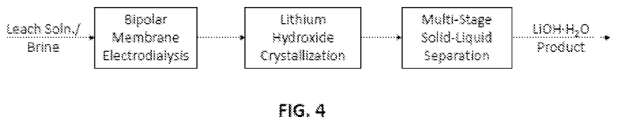

FIG. 4 is a schematic diagram of a simplified low-cost lithium selective ED membrane-based production process for LiOH production, in accordance with an example embodiment of the present disclosure.

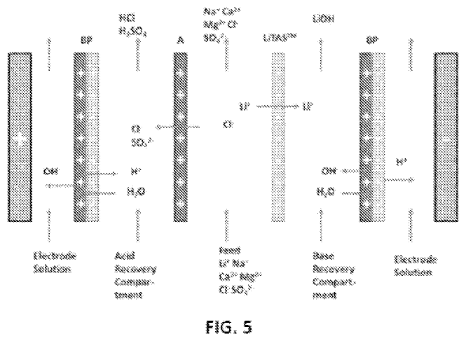

FIG. 5 is a schematic diagram of a bipolar membrane electrodialysis system for processing a feed brine containing unwanted monovalent and divalent cations and divalent anions with a highly Li selective membrane to directly produce a clean LiOH solution.

### DETAILED DESCRIPTION

Aspects of the disclosure are described more fully hereinafter with reference to the accompanying drawings, which form a part hereof, and which show, by way of illustration, example features. The features can, however, be embodied in many different forms and should not be construed as limited to the combinations set forth herein; rather, these combinations are provided so that this disclosure will be thorough and complete, and will fully convey the scope.

### Embodiments of the Invention

With respect to conventional BPED performed using commercially-available membranes, experimentation performed by the present research team has validated the insufficiency of such membranes when tested using brines with ˜1500 ppm (parts per million) hardness, confirming that commercial membranes cannot withstand high hardness levels. Such tests were performed using best-available commercial membranes for BPED. As shown in FIG. 1, there was a continuous increase in voltage during this constant-current commercial membrane test. FIG. 1 particularly illustrates a plot of voltage increase in a 10-triplet membrane stack at a constant current of 1.5 Amps (234 A/m²). The rise in voltage from 13.86 to 21.97 V, as shown in FIG. 1, is due to salt scaling (e.g., Mg(OH)₂ and/or Ca(OH)₂) on the membranes, which subsequently increases their resistance to ion permeation and thus increases the voltage required to maintain a constant current. Considerable amounts of Ca(OH)₂ and Mg(OH)₂ precipitates formed in the base product as the BPED test progressed due to passage of Ca²⁺ and Mg²⁺ through the CEM. After the 22-hour period had concluded, the stack was disassembled, and the membranes were inspected. This post-mortem analysis showed significant wrinkling, swelling, and scaling of the CEM, as shown in FIG. 2.

Responsive thereto, according to an embodiment of the present disclosure, a BPED process has been developed that has been named selective BPED (sBPED). According to an embodiment, the sBPED can employ a selective CEM with coatings that facilitate the selective permeation of monovalent ions much more readily than divalent ions (e.g., Ca²⁺ and Mg²⁺). In an embodiment, the present membrane can result in high Li⁺ selectivity over contaminants, such as Ca²⁺ and/or Mg²⁺. Mg²⁺ is common in brines around the world and can be particularly difficult to separate from Li-brines due to its similarity to Li⁺ in terms of ionic radius and chemical properties, while Ca²⁺ can be found in abundance, for example, in Salton Sea brines.

The use of sCEMs in the BPED process can enable simultaneous extraction and purification of Li brines using an enormously simplified process. As such, the sCEMs can be used to avoid the drawbacks of the non-selective BPED process. Further, unlike the conventional route, the present system/process can avoid forming lithium carbonate (Li₂CO₃) as an intermediate product. Instead, the sBPED process can be used to directly produce a high-purity LiOH product, where the purity level may be at least 95% (by weight) or even up to 99.99% (by weight).

In an embodiment, a portion (e.g., about half) of the sBPED base product can be used to synthesize the solid LiOH monohydrate (LiOH·H₂O(s)). This solid phase can be precipitated by an evaporative precipitation process. In an embodiment, for example, 70-90% (e.g., 85%) of the total volume can be evaporatively precipitated and then purified. In an embodiment, the precipitant can be washed with CO₂-free deionized water under a cold CO₂-free environment. The purified precipitant can be fully dried under vacuum and may be further recrystallized in order to obtain an even higher purity.

In an embodiment, a second portion (e.g., the other half) of the sBPED base product can be used for generating an end product of Li₂CO₃ (as opposed to being an unwanted intermediary). This carbonate end product can be formed by bubbling or otherwise delivering a CO₂-containing gas into the LiOH-containing base product. In an embodiment, the bubbling can occur until the solution is able to reach a sufficiently basic pH to drive lithium carbonate precipitation. In an embodiment, the pH to drive precipitation can be at least 10 or even at least 12 (e.g., 12.5). In an embodiment, an indicator of lithium precipitation can be the solution becoming turbid in the process. The solution and precipitated lithium carbonate may further be filtered under vacuum.

In an embodiment, the CO₂-containing gas can be generated from a direct air capture (DAC) system for CO₂ and/or via a flue gas system. Overall, the generation of high purity Li products can be performed from the BPED product and with the use of carbon negative CO₂, a carbon neutral or carbon negative lithium process can be developed. Through the use of a DAC-gas and/or flue gas source, carbon dioxide from such sources can be repurposed/recycled, and the need for high-purity/technical grade carbon dioxide may be obviated.

Using a suitable membrane such as LiTAS™, some or most of the currently used processing steps can be eliminated, resulting in much more efficient lithium hydroxide production from lithium-containing resources such as concentrated feed from direct lithium extraction processes, brine evaporation ponds, or by other means such as rock leachates.

The present disclosure provides methods for producing a substantially clean LiOH solution directly from admixtures containing Li and one or more impurities, by feeding the admixture to an electrodialysis or BPMED cell containing an ion selective membrane, and operating the ion selective membrane under a potential difference to obtain a separate LiOH solution, wherein the separate LiOH solution contains from about 2 to 14 wt % LiOH, Mg in the range of about 0 to 100 ppm, and Ca in the range of about 0 to about 100 ppm. Other LiOH concentrations within the separated LiOH solution also are possible, and the separated LiOH solution may contain other ions, such as Na and/or K. In an embodiment, the ion selective membrane is contained with a BPMED cell. Such a method and process is discussed in detail in PCT/US22/15850, filed Feb. 9, 2022, the contents of which are hereby incorporated by reference thereto.

In one case the admixture contains lithium in amounts of about 1,500 to about 60,000 ppm. In another, the admixture contains impurity ions selected from the group consisting of monovalent and divalent cations and divalent anions. The impurity ions may be selected from the group consisting of Mg, Ca, Na and K ions. In one aspect, the admixture contains a ratio of Li/Mg ions in the range of about 1 to about 40 or, more specifically, about 3 to about 20. In another aspect, the admixture contains a ratio of Li/Ca ions in the range of about 5 to about 100, about 1 to about 25, or, more specifically, about 5 to about 10. In yet another aspect, the admixture contains a ratio of Li/Na and Li/K ions in the range of about 1 to about 110 or, more specifically, about 1.5 to about 70. In an embodiment, the admixture can be a concentrated lithium brine from a process selected from the group consisting of pond evaporation, direct lithium extraction, and leaching of lithium minerals using water or acid or a concentrated lithium brine from a combination of such processes. In an embodiment, the admixture may comprise a rock leachate, such as from spodumene, jadarite, hectorite clays, zinnwaldite, and/or other lithium-bearing minerals. In an embodiment, the admixture may be derived from a battery recycling waste stream.

In one aspect, the ion selective membrane is selected from the group consisting of a lithium selective membrane, a monovalent cation selective membrane, or a cation over anion selective membrane. In an embodiment, the ion selective membrane can be a lithium selective membrane having a selectivity in the range of 10-100. In an embodiment, the term “selectivity,” in reference to, for example, lithium selectivity, can be defined here as the ratio of Li ions recovered/feed Li concentration, to the ratio of other ion recovered/other ion feed concentration. In an embodiment, the ion selective membrane can be a lithium selective membrane comprising a polymer matrix and metal organic framework (MOF) particles disbursed therein. In another embodiment, the cation selective membrane can be a cation over anion selective membrane and liming is performed before feeding the admixture to the ED cell containing the membrane.

In an embodiment, the process can bypass or at least significantly mitigate the need for formation of lithium carbonate as a precursor to LiOH. In another aspect, the process can be substantially free of lithium carbonate formation as a precursor to LiOH. In another embodiment, partial lithium separation as lithium carbonate, phosphate, oxalate or other precipitates may be produced from the feed brine, and the remaining lithium-containing feed then advances through electrodialysis to directly produce LiOH. The resulting lithium hydroxide solution can then be crystallized to produce lithium hydroxide monohydrate with a purity in the range of about 95 to 99.9 wt %. In another aspect, the lithium hydroxide solution can include lithium hydroxide in the range of from 5 to 14 wt %.

The present disclosure also provides a system configured to directly produce LiOH substantially without producing a lithium carbonate precursor. The system can include an ED or BPMED cell including an ion selective membrane selected from the group consisting of a lithium selective membrane, a monovalent selective membrane, or a cation over anion selective membrane; a feed inlet upstream of the membrane and configured to receive an admixture comprising a concentrated lithium brine from at least one process selected from the group consisting of pond evaporation, direct lithium extraction, and leaching of lithium minerals using water or acid; and an outlet downstream of the membrane configured to convey a LiOH solution containing from about 2 to about 14 wt % LiOH, Mg in the range of about 0 to 100 ppm, and Ca in the range of about 0 to about 100 ppm.

In an embodiment, the system can include a membrane that is a lithium selective membrane. In an embodiment, the membrane can be a selective coated ion exchange membrane (also referred to as a sCEM). In one aspect, the membrane can be a lithium selective membrane comprising a polymer matrix and MOF particles disbursed therein. In another aspect, the lithium selective membrane can have a selectivity in the range of Li/Mg. Ca of at least 10 and Li/Na, K of at least 3.

### Example Embodiments of the Disclosure

FIG. 3 illustrates a carbon-negative lithium compound generating system 100 and related process for generating battery-grade lithium carbonate and lithium hydroxide monohydrate via bipolar electrodialysis, according to an example embodiment of the present disclosure. The lithium compound generating system 100 can include an initial CO₂ source 102 (e.g., air, flue gas, etc.); a carbon dioxide capture device 104 (e.g., a device configured to yield an output gas with a higher CO₂ concentration than that of the source 102); and a concentrated CO₂-level (i.e., concentrated relative to a precursor gas) gas output 106, in a first portion of the overall system 100. The lithium compound generating system 100 can further include a lithium-containing source feed 108 (e.g., a lithium-containing brine); a bipolar electrodialysis system 110; and a LiOH aqueous product output 112, in a second portion of the overall system 100. The lithium compound generating system 100 can additionally include a first reaction site/chamber 114 (e.g., configured to facilitate Li₂CO₃ production from LiOH aqueous product and captured CO₂); a battery-grade Li₂CO₃ output 116; a second reaction site/chamber 118 (e.g., configured to facilitate LiOH·H₂O via evaporative crystallization); and a battery-grade LiOH-based output 120, in a third part of the system 100. The system 100 can further include any conduits, valves, flow sensors, controllers, etc., (not shown or at least not labeled) needed to facilitate the operation thereof. In an embodiment, the first reaction site/chamber 114 and/or the second reaction site/chamber 118 can include a container sufficiently sealed to confine a given reaction and appropriate inlets and outlets relative thereto.

In an embodiment, the initial CO₂ source 102 can be, for example, air and/or flue gas, and the carbon dioxide capture device 104 can be any device or system configured to increase the CO₂ concentration than that of the source 102. For example, the carbon dioxide capture device 104 can be a direct air capture device that may increase the carbon dioxide concentration from that typically found in air (e.g., 0.04% by volume) by factor of at least 50 or more (e.g., increasing it to 2% or more by volume; or 5-100% by volume; or 30% or more by volume). Such direct air capture devices are known in the art, and any such unit providing a sufficient volume percentage of CO₂ as part of its concentrated CO₂ gas output 106 to generate a sufficient reaction throughput of lithium carbonate may be employed. With respect to the use of flue gas usage, in an embodiment, the carbon dioxide capture device 104 may be used to reduce the presence of any unwanted gases (e.g., sulfur dioxide, oxides of nitrogen, etc., for example, capturing and/or diverting such gases) that may otherwise interfere with producing high-purity lithium carbonate and, in that process, increase the volume fraction of carbon dioxide therein.

In an embodiment, the lithium compound generating system 100 can direct a lithium-containing source feed 108 into a bipolar electrodialysis system 110, thereby yielding the LiOH aqueous product output 112. The lithium-containing source feed 108 can be a naturally-occurring lithium-containing brine, a partially processed lithium-containing brine, or another lithium-carrying solution (e.g., a by-product of a chemical process; a recycled brine solution; a lithium solution undergoing further purification; etc.). In an embodiment, the lithium-containing brine may be previously unconcentrated (e.g., pumped from a natural or other original source) or may have been partially concentrated (e.g., subject to one or more treatments and/or evaporation stages).

Per an example test, a synthetic Salton Sea brine was created with the following composition: 15,000 ppm Li, 1,500 ppm Ca, 500 ppm B, and 100 ppm Mg. The brine was treated with bipolar electrodialysis (BPED), utilizing Li-selective cation exchange membranes, in accordance with the present system. After 23 hours of batch testing run time, the final base product contained 6.86% LiOH (aq) with 24 ppm Ca, 67 ppm B, and nondetectable amounts of Mg.

Ion Selectivity Cumulative

| Time | Li/Ca | Li/Na | Li/K | Li/B |
|---|---|---|---|---|
| 0 | | | | |
| 4 | 245.8 | 5.1 | −7.0 | 1966.0 |
| 20 | 936.3 | 5.1 | 14.0 | 295.7 |
| 23 | 1011.7 | 5.3 | 17.0 | 256.7 |

The current sCEM yield high selectivity of lithium over other ions. The Ca selectivity can be extremely high, and the Mg selectivity can be almost infinite. The Na and K can most likely be impacted by the high TDS (total dissolved solids) of Li and, therefore, gives a concentration-induced selectivity.

The details of at least one embodiment of a given bipolar electrodialysis system 110 for yielding the LiOH aqueous product output 112 will be discussed in greater detail later in the application.

In an embodiment, at least a first portion of the LiOH aqueous product output 112, along with the concentrated CO₂ gas output 106, can be used toward generating lithium carbonate at the first reaction site/chamber 114. In an embodiment, any desired portion (e.g., 50%, 50-100%, 25%, etc., by volume of the available total) of the LiOH aqueous product output 112 can be used toward battery-grade lithium carbonate production. In an embodiment, the concentrated-level CO₂ gas (e.g., captured CO₂-carrying gas) can be bubbled/injected through the LiOH aqueous product in the first reaction site/chamber 114 to thereby yield a battery-grade lithium carbonate. The bubbling can be performed until a sufficiently basic pH to facilitate precipitation is reached. In an embodiment, the bubbling of the CO₂-containing gas (e.g., capture release gas) can be performed at room/ambient temperature (e.g., reaction between LiOH and CO₂ is exothermic). For example, at a pH of 10 or more (e.g., 12.5), the solution can become turbid and drive precipitation of lithium carbonate therefrom. In an embodiment, the product and/or solution upon bubbling can be filtered under a vacuum and the precipitant fully dried.

In an embodiment, the carbon dioxide in the captured CO₂-carrying gas may be pulled out a power plant (e.g., a flue gas) or directly out of air (e.g., via direct air capture). In an embodiment, the act of using CO₂ from the environment to produce lithium carbonate from a BPED LiOH product can be considered to be a carbon negative process. In an embodiment, the system 100 can yield, for example, the following precipitants and related purity levels:

Purity of BPED precipitated products

| Product Type | Purity (%) |
|---|---|
| LiOH•H₂O (s) | 96.2 |
| Li₂CO₃ (s) | 99.7 |

In an embodiment, a second portion (e.g., less than 100%, 40-60%, 50%, 25-75%, etc., by volume of the available total) of the LiOH aqueous product output 112 can be routed to the second reaction site/chamber 118. At the second reaction site/chamber 118, lithium hydroxide monohydrate can be formed, such as by evaporative precipitation, and outputted in a battery-grade form and/or purity. In an embodiment, at the second reaction site/chamber 118, 85% (by total volume) of the LiOH aqueous product may be evaporated. The precipitated product can be purified by washing with cold CO₂-free deionized water under a cold CO₂-free environment. The purified precipitant can then be fully dried under vacuum. This product can be further recrystallized in order to obtain yet a higher purity.

As shown in FIG. 4, brine or mineral leach solutions (e.g., lithium chloride or sulfate liquor) can be directly subjected to electrodialysis using a lithium selective cationic membrane. The lithium selective cationic membrane largely permits only lithium ions to transfer, producing a high concentration lithium hydroxide solution ready for evaporative crystallization. Thus, application of, for example, a highly Li/Na selective ED membrane can provide a pathway to direct LiOH production from less concentrated and impure brines, and can eliminate the intermediary Li₂CO₃ processing requirement, and associated capital and operating costs.

If the Mg, Ca loading of the feed brine is high, lime-soda softening steps and/or other hardness reduction steps (e.g. one or more preliminary electrodialysis, solvent extraction, or resin/absorbent extraction step) may optionally be performed before electrodialysis directly to LiOH, again bypassing intermediary Li₂CO₃ processing requirements. Significant capital and operating cost savings are still retained in this process.

By “direct” or “directly” herein with reference to LiOH production, we mean systems and processes which are capable of substantially bypassing production of the intermediate lithium carbonate precursor to LiOH and, in most cases, also bypassing pre-polishing of naturally occurring brine, Li-containing rock leachate, or feed from DLE (direct lithium extraction) processes. Advantageously, we have found that the methods and systems taught herein substantially reduce the number of processing steps to yield highly concentrated LiOH from Li-containing feed stock that includes naturally occurring and/or other impurities. The resulting LiOH solutions can readily be crystallized by, for example, evaporation to yield substantially pure (for example, at least 95% (by weight) pure or 95 to 99.9% pure) lithium hydroxide monohydrate.

As used herein, the term “cation selective electrodialysis membranes” or “cation exchange membranes” or “cation over anion selective membranes” means membranes that are selective between cations and anions, but are not selective between cations such as Li and Na, K, Ca or Mg. Therefore, in the presence of non-lithium impurity cations, such membranes can pass the impurity cations along with lithium to yield a mixed hydroxide. “Monovalent selective membranes” or “monovalent selective cation exchange membranes” means membranes that are selective between monovalent and divalent ions, and thus permit monovalent ions such as Na, K and Li while retarding divalent/multivalent cations, like Ca or Mg. “Monovalent selective membranes” can also be monovalent selective anion exchange membranes that permit passage of essentially only monovalent anions like Cl— or F— while retarding divalent anions like SO₄². “Conventional electrodialysis membranes” means membranes that discriminate between cations and anions and are essentially non-selective between monovalent and divalent ions.

“Electrodialysis” means using one or more ion exchange membranes to separate ions from a feed stream into different ion streams under an applied electric potential difference. Any suitable electric potential difference can be used, for example, but not limited to, electrical current in the range of 400 to about 3000 A/m².

“Bipolar membrane electrodialysis” or BPMED means an electrodialysis process or system, wherein anions and cations are selectively transported across semi-permeable membranes under an electric potential to drive the ions and achieving their separation from a carrier such as water. Bipolar membranes typically comprise cationic and anionic exchange membranes sandwiched together with a hydrophilic interface at their junction. Under an applied current, water molecules migrating to the hydrophilic junction are split into H+ and OH-ions, which migrate to produce acids and bases with other anions and cations. A typical BPMED system as used herein is shown in FIG. 5 by way of illustration only; various other BPMED setups are possible using the teachings herein.

The feed compositions herein may contain impurity ion ratios of Li/Mg typically greater than 3, more typically greater than 5, and Li/Ca ratios greater than 1.5, typically greater than 3.5. The feed lithium content is typically greater than 1,000 ppm, greater than 5,000 ppm, or greater than 10,000 ppm. For example, the feed used herein may have compositions containing unwanted impurity ions (such as monovalent and divalent cations and divalent anions) with impurity ion ratios of Li/Mg from 1 to 40, from 3 to 20, or, more particularly, from 5 to 15, and Li/Ca ratios from 5 to 100, typically from 20 to 50, and Li/Na, K ratios from 1.5 to 10, typically from 3.5 to 7.5 and a feed lithium content typically from 1000 to 60,000 ppm, preferably from 5000 ppm to 25,000 and, in the case of pond evaporated brines, typically from 10,000 to 60,000 ppm.

Resulting LiOH solutions from the methods and systems disclosed herein will typically contain highly concentrated LiOH. For example, LiOH concentration ranges of about 2 to 14% by weight LiOH can be achieved. In some embodiments, the LiOH concentration is at least 5%. Other concentrations are also possible. Advantageously, these concentrations can readily be crystallized to yield substantially pure lithium hydroxide monohydrate.

With respect to the present disclosure, it has been found that the required membrane Li/Mg, Ca selectivity can be a function of the feed Li/Mg and Li/Ca ratios. For Li/Mg and Li/Ca ratios greater than 10, as is typical for Chilean concentrated brines, a Li/Mg, Ca selectivity greater than 10 can be preferred, and more preferably the Li/Mg, Ca selectivity is greater than 30, or greater than 50. For feed Li/Mg ratios less than 10, as may be the case for some Argentinian brines, Li/Mg selectivity greater than 75 can be preferred. Around a feed Li/Mg ratio of 2-5, an approach may be optionally used that involves chemical precipitation of Mg before performing direct electrodialysis to LiOH. In this case, the Li/Mg selectivity may be approximately 10 or greater, and preferably greater than 30. In all cases, a higher Li/Na, K selectivity exceeding 10 can be beneficial but not required, and can be especially beneficial for the approach in which Mg is first chemically precipitated. Given the teachings herein, suitable selectivities may be chosen based on the feed impurity contents, such that a membrane of a stated selectivity directly yields a non-precipitating LiOH solution, preferably with maximum Mg and Ca contents of less than or equal to about 3 ppm and about 5 ppm, respectively. These Ca and Mg numbers can be higher than what can be calculated using the solubility products of Kₛₚ(Mg(OH₂))=5.61E-12 and Kₛₚ(Ca(OH₂))=5.02E-6 (as known in the art). However, as referred to in the prior art, higher concentrations of Ca and Mg up to 4 and 0.55 mg/L were reported during a long pilot run producing LiOH using electrodialysis from an ultra-purified brine. Without wishing to be bound by theory, the higher levels of Ca and Mg compared to those calculated from solubility products may indicate some stabilizing mechanism that allows them to remain in solution, probably due to the activities of components and stabilizing influence of other impurity ions. We have experimentally verified that up to 5 mg/L of both Ca and Mg can remain in solution in a 5% LiOH solution.

It should be understood that membranes useful in embodiments of the present disclosure can include any membrane which can achieve separation of at least a portion of monovalent ions or lithium from one or more impurities, and preferably targeted monovalent-monovalent and/or monovalent-multivalent separations.

As an example, one particularly suitable membrane can be a LiTAS™ membrane. Such membranes have been shown to possess monovalent-divalent ion selectivity up to and greater than 500 utilizing metal organic frameworks (MOFs) components. Such membranes also have demonstrated a corresponding Li—Mg selectivity of 1500 (as discussed in the art). LiTAS™ membranes can also be provided incorporating Li—Na selective MOFs which have demonstrated selectivities of around 1000.

By “LiTAS™” membrane technology, we mean lithium-ion transport and/or separation using metal organic framework (MOF) nanoparticles in a polymer carrier. MOFs have exceptionally high internal surface area and adjustable apertures that achieve separation and transport of ions while only allowing certain ions to pass through. These MOF nanoparticles are materialized like a powder, but when combined with polymer the combined MOF and polymer can create a mixed matrix membrane embedded with the nanoparticles. The MOF particles create a percolation network, or channels, that allow selected ions to pass through. When extracting lithium, the membrane is placed in a module housing. Feed such as evaporated brine is pumped through the system with one or more layers of membranes that conduct effective separation even at high salinities. While current separator technology can fall short in one area or another, LiTAS™ membrane technology can be quite effective. LiTAS™ Membrane Technology U.S. Patent Application No. 62/892,439, filed Aug. 27, 2019, U.S. Patent Application No. 62/892,440, filed Aug. 27, 2019, International Patent WO Publication Number 2019/113649A1, published Jun. 20, 2019, and International Patent Application Number PCT/US2020/047955, filed Aug. 26, 2020, are hereby incorporated herein by reference in their entireties.

Membranes for use herein can also be monovalent selective cation exchange membranes with sufficiently high lithium/divalent selectivity depending on feed brine Mg content and the type of application (FIG. 1b or 1c). For example, the prior art refers to monovalent selective membranes for Li—Mg separation from high Mg content brines achieving high Li recovery and a good selectivity of 20-33.

Another example is a membrane containing ionophores, which are materials that transport specific ions across semi-permeable surfaces or membranes as discussed in the art. Such ionophores are based on 14-crown-4 crown ether derivatives. Other potential examples are supported liquid membranes or ionic liquid membranes in electrodialysis, as described in a review article by Li et al., 2019 where cation selective membranes (with Li—Mg selectivity between 8-33, Li—Ca selectivity around 7, Li—Na selectivity around 3, and Li—K selectivity around 5) are described.

Referring now to FIG. 5, LiTAS™ membranes applied in a BPMED setup are shown. In an embodiment, FIG. 5 can be considered as illustrating a system of bipolar membrane electrodialysis of feed brine (e.g., containing unwanted monovalent and/or divalent cations; and/or divalent anions) using highly Li selective (for example, LiTAS™) membranes, to produce clean LiOH solutions. In this setup, the electrodialysis cell can be arranged into three compartments in addition to the electrode rinse channels adjacent to the end electrodes. The three-compartment unit containing a cation exchange membrane, bipolar membrane, and an anion exchange membrane can be configured as repeating units. Any number of repeating units in the ED or BPMED cells is contemplated hereby. The cation exchange membrane in this example is a Li-selective membrane, allowing essentially only lithium ions and water along with minor amounts of impurities to permeate. These membranes can also be monovalent selective, which permit passage of monovalent ions, such as Na, K and Li, while retarding divalent/multivalent cations, like Ca or Mg. The bipolar membrane can be a sandwiched cation and anion exchange membrane, as described above. The positively charged anion exchange membrane substantially permits only the negatively charged anions to pass, repulsing the positively charged cations. These membranes may also be monovalent selective, permitting essentially only monovalent anions like chloride to permeate relative to the divalent anions such as sulfate.

The feed can enter the central compartment in each repeating unit. With a Li-selective membrane, substantially only Li permeates through the membrane into the adjacent base recovery compartment. Similarly, anions can permeate through the anion exchange membrane to the acid recovery compartment. The bipolar membranes on the other side of the compartments can provide either H+ ion to the acid recovery compartment or OH-ions to the base recovery compartment. In this fashion, a clean LiOH stream can be produced directly from the feed brine and/or leach solution.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A lithium compound generating system, comprising:
(I) a source of a first carbon dioxide containing gas, the first carbon dioxide containing gas including a first concentration of carbon dioxide;
(II) a carbon dioxide capture unit configured to receive the first carbon dioxide containing gas and to output a release gas, the release gas including a second concentration of carbon dioxide greater than the first concentration of carbon dioxide, the second concentration of carbon dioxide configured to be achieved by a carbon capture process;
(III) a lithium-containing source feed for providing a lithium-containing material;
(IV) a bipolar electrodialysis unit for receiving and processing the lithium-containing material, the bipolar electrodialysis unit including at least one bipolar membrane, the bipolar electrodialysis unit configured to generate an aqueous lithium hydroxide product including lithium hydroxide; and
(V) a first reaction site configured to receive the release gas from the carbon dioxide capture unit and at least a first portion of the aqueous lithium hydroxide product, the first reaction site configured to facilitate a first reaction between the carbon dioxide included in the release gas and the lithium hydroxide of the first portion of the aqueous lithium hydroxide product, the first reaction configured to yield an amount of lithium carbonate.

2. The lithium compound generating system of claim 1, wherein the source of a carbon dioxide containing gas is at least one of a direct air capture source or a flue gas source.

3. The lithium compound generating system of claim 1, wherein the source of a carbon dioxide containing gas includes a direct air capture source, the direct air capture source including about 0.04% by volume of carbon dioxide, the carbon dioxide capture unit configured to capture the carbon dioxide therein and to thereby output a given release gas with at least 2% by volume of carbon dioxide.

4. The lithium compound generating system of claim 3, wherein the carbon dioxide capture unit is configured to output a given release gas with at least 30% by volume of carbon dioxide.

5. The lithium compound generating system of claim 1, wherein the first reaction site is configured to generate an amount of battery-grade lithium carbonate.

6. The lithium compound generating system of claim 1, wherein the first reaction site is configured to bubble the release gas from the carbon dioxide unit through the at least a first portion of the aqueous lithium hydroxide product at room temperature.

7. The lithium compound generating system of claim 1, wherein the first reaction site is further configured to filter the lithium carbonate under vacuum.

8. The lithium compound generating system of claim 1, wherein the lithium-containing source feed comprises a brine feed.

9. The lithium compound generating system of claim 1, further comprising a second reaction site configured to receive a second portion of the aqueous lithium hydroxide product, the second reaction site configured to facilitate evaporative crystallization of the lithium hydroxide of the second portion of the aqueous lithium hydroxide product, the second reaction site configured to yield an amount of lithium hydroxide monohydrate.

10. The lithium compound generating system of claim 8, wherein the second reaction site is further configured to wash and thereby purify the lithium hydroxide monohydrate.

11. The lithium compound generating system of claim 9, wherein the second reaction site is further configured to wash the lithium hydroxide monohydrate with CO₂-free deionized water under a cold CO₂-free environment.

12. A lithium compound generating process, comprising:
(I) providing a first carbon dioxide containing gas, the first carbon dioxide containing gas including a first concentration of carbon dioxide;
(II) receiving the first carbon dioxide containing gas in a carbon dioxide capture unit, the carbon dioxide capture unit outputting a release gas, the release gas including a second concentration of carbon dioxide greater than the first concentration of carbon dioxide, the carbon dioxide capture unit using a carbon capture process to generate the second concentration of carbon dioxide;
(III) providing a lithium-containing source feed, the lithium-containing source feed including a lithium-containing material;
(IV) receiving and processing the lithium-containing material in a bipolar electrodialysis unit, the bipolar electrodialysis unit including at least one bipolar membrane, the bipolar electrodialysis unit generating an aqueous lithium hydroxide product including lithium hydroxide; and
(IV) receive the release gas from the carbon dioxide unit and at least a first portion of the aqueous lithium hydroxide product at a first reaction site, the first reaction site facilitating a first reaction between the carbon dioxide included in the release gas and the lithium hydroxide of the first portion of the aqueous lithium hydroxide product, the first reaction yielding an amount of lithium carbonate.

13. The lithium compound generating process of claim 12, wherein the source of a carbon dioxide containing gas is at least one of a direct air capture source or a flue gas source.

14. The lithium compound generating process of claim 12, wherein the source of a carbon dioxide containing gas includes a direct air capture source, the direct air capture source including about 0.04% by volume of carbon dioxide, the carbon dioxide capture unit configured to capture the carbon dioxide therein and to thereby output a given release gas with at least 2% by volume of carbon dioxide.

15. The lithium compound generating process of claim 12, further comprising a step of receiving a second portion of the aqueous lithium hydroxide product at a second reaction site, the second reaction site configured to facilitate evaporative crystallization of the lithium hydroxide of the second portion of the aqueous lithium hydroxide product, the second reaction site configured to yield an amount of lithium hydroxide monohydrate.

16. The lithium compound generating process of claim 12, wherein the second reaction site is further configured to wash and thereby purify the lithium hydroxide monohydrate.
